(19) United States
(12) Patent Application Publication
(10) Pub. No.: US 2024/0258020 A1
(43) Pub. Date: Aug. 1, 2024

(54) COIL COMPONENT AND CIRCUIT BOARD

(71) Applicant: Taiyo Yuden Co., Ltd., Tokyo (JP)

(72) Inventor: Daiki Mimura, TOKYO (JP)

(21) Appl. No.: 18/423,612

(22) Filed: Jan. 26, 2024

(30) Foreign Application Priority Data
Jan. 31, 2023 (JP) 2023-012621

(51) Int. Cl. H01F 27/29; H01F 27/06; H01F 27/255; H01F 27/34

(52) U.S. Cl. CPC H01F 27/292; H01F 17/0006; H01F 27/255; H01F 27/346; H01F 2017/0073

(57) ABSTRACT

Disclosed herein is a coil component including a conductor including a circling portion and an extension portion, a magnetic base containing magnetic metal particles and including the circling portion, and an external electrode electrically connected to the extension portion. The magnetic base includes a first magnetic portion containing first magnetic metal particles and a second magnetic portion containing second magnetic metal particles with a particle size smaller than that of the first magnetic metal particles, the first magnetic portion is positioned on one side and the second magnetic portion is positioned on another side across the circling portion. The external electrode is provided in contact with the first magnetic portion.

### CROSS REFERENCE TO RELATED APPLICATIONS

This application claims priority benefit of Japanese Patent Application No. JP 2023-012621 filed in the Japan Patent Office on Jan. 31, 2023. Each of the above-referenced applications is hereby incorporated herein by reference in its entirety.

### BACKGROUND

The present disclosure relates to a coil component and a circuit board.

Along with the increased performance of electronic devices, the numbers of electronic components used in the electronic devices have increased, and downsizing of the electronic components is necessary. The operating speed of many electronic devices has increased, and the loss associated with the increased speed also needs to be suppressed.

The downsizing and the suppression of loss are also necessary in coil components, and the magnetic performance needs to be more efficiently obtained along with further downsizing of the coil components. Particularly, the loss caused by the current needs to be suppressed to a low level when a relatively high current is used in a coil component with magnetic metal material. Therefore, a material with a small loss needs to be selected as a magnetic metal material.

An inductor downsized by increasing the filling rate of magnetic metal powder is disclosed in, for example, Japanese Patent Laid-Open No. 2016-225479.

### SUMMARY

However, the proportion of the magnetic metal material in the coil component decreases when the size and the thickness of the coil component are further reduced, and the magnetic flux formed in the coil component is leaked outside the coil component. As a result, a loss occurs when the leaked magnetic flux passes through the metal. For example, external electrodes of many coil components are provided on the surfaces of magnetic bases, and the loss occurs when the leaked magnetic flux passes through the external electrodes.

In view of the circumstances, it is desirable to provide a coil component that can secure the permeability and suppress the loss.

An embodiment of the present disclosure provides a coil component including a conductor including a circling portion and an extension portion, a magnetic base containing magnetic metal particles and including the circling portion, and an external electrode electrically connected to the extension portion, in which the magnetic base includes a first magnetic portion containing first magnetic metal particles and a second magnetic portion containing second magnetic metal particles with a particle size smaller than that of the first magnetic metal particles, the first magnetic portion is positioned on one side and the second magnetic portion is positioned on another side across the circling portion, and the external electrode is provided in contact with the first magnetic portion.

In the coil component according to an embodiment of the present disclosure, the external electrode is provided separately from the second magnetic portion.

In the coil component according to an embodiment of the present disclosure, a minimum thickness of the second magnetic portion is smaller than a minimum thickness of the first magnetic portion.

In the coil component according to an embodiment of the present disclosure, the first magnetic portion is provided on a side closer to a bottom surface of the magnetic base, the bottom surface side facing a board when the coil component is mounted, and the second magnetic portion is provided on a side closer to an upper surface of the magnetic base, the upper surface side being opposite the bottom surface side. The coil component is mounted on the board by the external electrode provided on the bottom surface.

According to the present disclosure, the permeability can be secured, and the loss can be suppressed.

### BRIEF DESCRIPTION OF THE DRAWINGS

FIG. 1 is a perspective view illustrating a coil component according to a first embodiment of the present disclosure;

FIG. 2 is a front view of the coil component according to the first embodiment;

FIG. 3 is a cross-sectional view of the coil component according to the first embodiment;

FIG. 4 is a cross-sectional view illustrating a structure of a magnetic base;

FIG. 5 is a schematic enlarged view illustrating a microscopic structure of a first magnetic portion;

FIG. 6 is a schematic enlarged view illustrating a microscopic structure of a second magnetic portion;

FIG. 7 depicts a coil component of a second embodiment;

FIG. 8 depicts a coil component of a third embodiment; and

FIG. 9 is a graph illustrating Q-value and inductance in an example.

### DETAILED DESCRIPTION OF THE PREFERRED EMBODIMENTS

Embodiments of the present disclosure will now be described in detail with reference to the attached drawings. Note that the following embodiments do not limit the present disclosure, and all combinations of the features described in the embodiments are not necessarily essential for the configuration of the present disclosure. The configuration of the embodiments may be appropriately modified or changed according to the specifications or various conditions (such as conditions of use and environment of use) of an apparatus in which the present disclosure is applied.

The technical scope of the present disclosure is defined by the claims and is not limited by the following individual embodiments. In the drawings used in the following description, the scale and the shape of each component may be different from those of the actual structure in order to facilitate the understanding of the component. Constituent elements illustrated in drawings described before may appropriately be referenced in later description of other drawings.

### First Embodiment

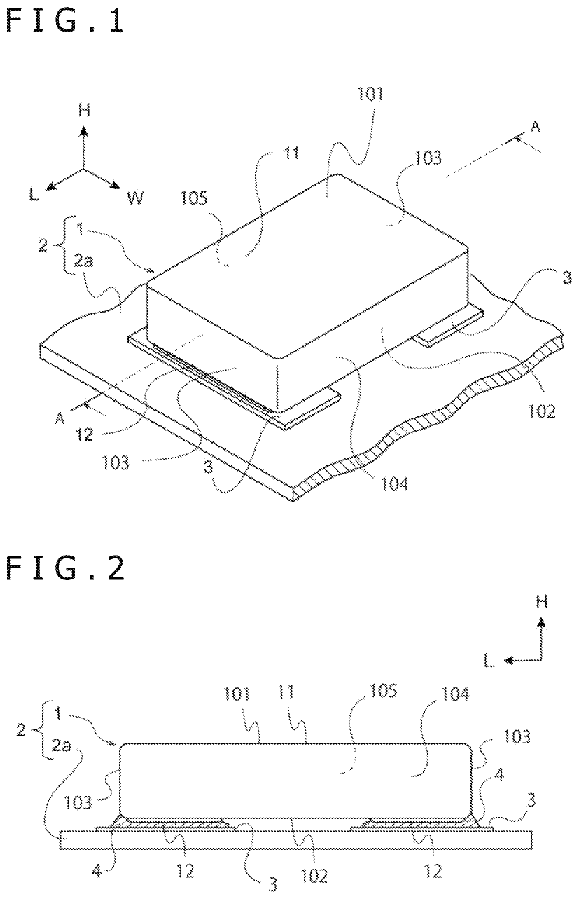

FIG. 1 is a perspective view illustrating a coil component according to a first embodiment of the present disclosure.

A coil component 1 is mounted on a board 2a. The board 2a is provided with, for example, two land portions 3. The coil component 1 includes one magnetic base 11 and two external electrodes 12. The external electrodes 12 and the land portions 3 are joined by soldering to mount the coil component 1 on the board 2a. The area of the land portion 3 is equal to or smaller than 1.6 times the area of the external electrode 12 as viewed in an H-axis direction. It is more desirable that the area of the land portion 3 be equal to or smaller than 1.3 times the area of the external electrode 12 as viewed in the H-axis direction.

A circuit board 2 according to one embodiment of the present disclosure includes the coil component 1 and the board 2a on which the coil component 1 is mounted. The circuit board 2 can be included in various electronic devices. Examples of the electronic devices including the circuit board 2 include electrical components of a car, a server, a board computer, and various other electronic devices.

In the present specification, the description of directions is based on an “L-axis” direction, a “W-axis” direction, and an “H-axis” direction of FIG. 1, and they will be referred to as a “length” direction, a “width” direction, and a “height” direction, respectively, unless otherwise understood in context. The “height” direction will be referred to as a “thickness” direction is some cases.

The external shape of the coil component 1 is a cuboid shape. That is, the coil component 1 includes external surfaces at both ends in a length direction L, both ends in a height direction H, and both ends in a width direction W.

The dimension of each side of the coil component 1 with the cuboid shape is in a range of, for example, 1.0 to 4.5 mm in the length direction L. The dimension of each side is in a range of, for example, 0.5 to 3.2 mm in the width direction W. The dimension of each side is in a range of, for example, 0.5 to 1.0 mm in the height direction H. The height direction H is shorter than the length direction L, and the height direction H is shorter than the width direction W.

The external surfaces of the coil component 1 may be flat surfaces or may be curved surfaces. Eight corners and twelve ridge lines of the coil component 1 may be roundish.

In the present specification, the shape of the coil component 1 may be referred to as a “cuboid shape” even when some of the external surfaces of the coil component 1 are curved or even when the corners and the ridge lines of the coil component 1 are roundish. That is, the “cuboid” and the “cuboid shape” in the present specification do not mean a “cuboid” in a strict mathematical sense.

### <Structure of Coil Component>

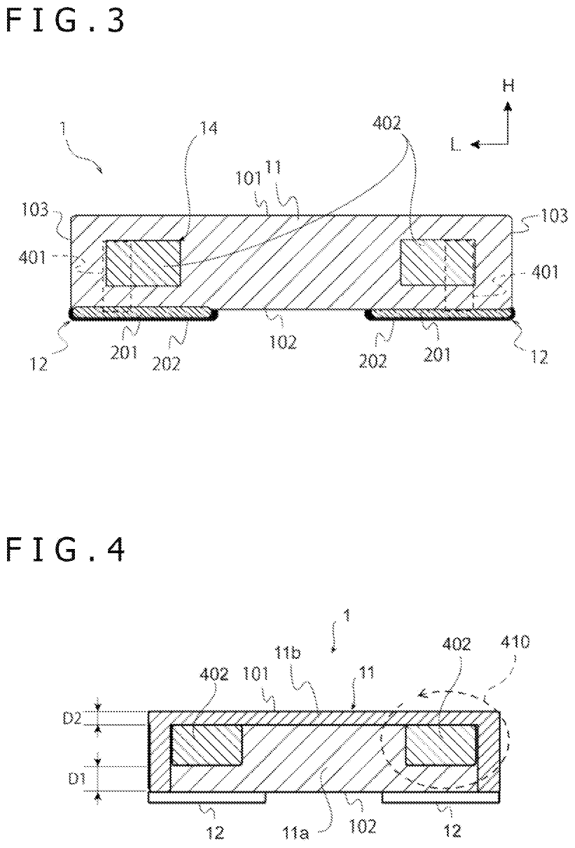

FIG. 2 is a front view of the coil component 1 illustrated in FIG. 1, and FIG. 3 is a cross-sectional view of the coil component 1 illustrated in FIG. 1. FIG. 3 illustrates a cross section along a line A-A illustrated in FIG. 1. The coil component 1 will be described with reference to FIGS. 1 to 3.

The coil component 1 according to the first embodiment of the present disclosure includes the magnetic base 11 and the external electrodes 12 and includes a conductor 14 inside the magnetic base 11.

The magnetic base 11 in the present embodiment is a magnetic body formed from a magnetic metal material and a binder. The binder binds the magnetic metal materials with each other, and a highly insulating binder is used in order to prevent electrical connection. The binder makes the specific resistance of the magnetic base 11 equal to or greater than 10⁶ Ωcm. For example, a binder that makes the specific resistance equal to or greater than 10⁸ Ωcm may be selected, and resin, glass, or metal oxide may be selected as the binder in order to increase the mechanical strength.

For example, resin with a glass transition point (Tg) higher than 150° C. is selected as the resin of the binder, and Tg may be higher than 180° C. As with glass and metal oxide, the resin with high Tg can react to an environmental change even when the resin is used at high temperature.

The specific resistance inside the magnetic base 11 is significantly high, and the specific resistance is also significantly high on the surface. The binder is also provided on the surface. The magnetic metal material contains magnetic metal particles of one or more of Fe, Ni, and Co. The magnetic metal material may contain magnetic ceramic particles of one or more of Mg, Mn, and Ni or non-magnetic particles such as silica, in addition to the magnetic metal particles. The magnetic metal particles may contain one or more components of Si, Cr, Al, B, and P in addition to components Fe, Ni, and Co, or a plurality of types of magnetic metal particles may be combined. The magnetic metal particles are bound by an insulator, and therefore, the magnetic base 11 is insulating. The insulator contains resin, oxide, or nitride.

When the magnetic metal material further contains other materials, such as fine metal particles, metal oxide, and a ceramic material in addition to the magnetic metal particles, the particle size of each of the other materials is 0.01 to 1 μm on average, and the particle size is smaller than that of the magnetic metal particles. The inclusion of a material other than the magnetic metal particles allows, for example, reducing the air gap or enhancing the mechanical strength, more so than improving the magnetic function.

The filling rate of the magnetic metal material in the magnetic base 11 is equal to or greater than 79 vol % and equal to or smaller than 87 vol %, and the rest is something other than the magnetic metal material. The magnetic base 11 contains an insulator or an air gap.

The magnetic base 11 has a cuboid shape. The magnetic base 11 includes an upper surface 101 at one end in the height direction H, a bottom surface 102 at the other end in the height direction H, end surfaces 103 at ends in the length direction L, and a front surface 104 and a back surface 105 at ends in the width direction W. The bottom surface 102 is a surface facing the board 2a when the coil component 1 is mounted on the board 2a.

The conductor 14 contains a metal material excellent in conductivity. An example of the metal material used for the conductor 14 includes one or more metals of Cu, Al, Ni, or Ag or an alloy containing one of these metals. A metal conducting wire provided with an insulating film on the surface may be wound to form the conductor 14, or the conductor 14 may be formed by plating or printing on, for example, the surface of a board or a sheet.

The conductor 14 of the present embodiment includes a circling portion 402 circled one or more turns. The number of circles of the circling portion 402 is, for example, equal to or greater than 1.5 turns and equal to or smaller than 10.5 turns. When the length direction L of the coil component 1 is, for example, 1.0 to 2.5 mm, the number of circles is, for example, equal to or greater than 1.5 turns and equal to or smaller than 6.5 turns. The shape of the circling portion 402 may be a planar shape or may be a spiral shape. The circling portion 402 may include, for example, a set of two circles facing each other on the upper side and the lower side.

The conductor 14 includes extension portions 401 for electrical connection to the outside. The extension portions 401 are provided at ends of the circling portion 402, and the extension portions 401 connect the external electrodes 12 to the conductor 14. A process of winding, coating, or laminating is used to produce the conductor 14, and the process is not particularly limited.

FIG. 3 illustrates the circling portion 402 with what is generally called horizontal winding in which the conducting wire is circled along the bottom surface 102 and the upper surface 101 of the magnetic base 11. The conductor 14 may 14 mayinclude a circling portion with what is generally called vertical winding in which the conducting wire is circled along the end surfaces 103 of the magnetic base 11.

The coil component 1 includes the two external electrodes 12 on the bottom surface 102 of the magnetic base 11. The external electrode 12 includes a metal layer containing one or more metals of Ag, Cu, Ti, Ni, and Sn. The metal layer is a layer with a thickness of, for example, 1 to 5 μm. A plurality of metal layers may be combined to form the external electrode 12, and the total thickness may be, for example, 5 to 10 μm. Metal layers, some of which containing resin, may be combined to form the external electrode 12, and the total thickness may be, for example, 10 to 20 μm.

The external electrode 12 includes one of or both a layer containing the same components as the conductor 14 and a layer containing components with resistance higher than the conductor 14. The external electrode 12 includes one of or both a layer with the same filling rate as the conductor 14 and a layer with a filling rate lower than the conductor 14.

In the case of the example illustrated in FIG. 3, each of the external electrodes 12 includes a base layer 201 and a plating layer 202. A metal material, such as Ag, Cu, Ti, and Ni, is used for the base layer 201. The base layer 201 is provided on the surface of the magnetic base 11 by plating, application of a metal material, a sputtering method, or a deposition method. The thickness of the base layer 201 is equal to or smaller than 1 μm, and part of the base layer 201 may be separated from the other part. The base layer 201 comes in close contact with the surface of the magnetic base 11 and the extension portion 401 of the conductor 14. In this way, the base layer 201 integrates the external electrode 12 with the magnetic base 11 and electrically connects the external electrode 12 and the conductor 14.

The plating layer 202 contains a metal material excellent in conductivity. Examples of the metal material include Cu and Ag, and further, Ni, Pd, and Sn are used. Layers, each containing each metal material as a major component, and some alloyed layers are placed on top of each other to form the plating layer 202 in layers.

### <Structure of Magnetic Base>

FIG. 4 is a cross-sectional view illustrating a structure of the magnetic base 11. The cross section illustrated in FIG. 4 is a cross section of the same section as in the cross-sectional view of FIG. 3, and FIG. 4 mainly illustrates a detailed structure of the magnetic base 11.

The magnetic base 11 includes a first magnetic portion 11a and a second magnetic portion 11b, and the circling portion 402 of the conductor 14 is placed between the first magnetic portion 11a and the second magnetic portion 11b. That is, the magnetic base 11 includes the first magnetic portion 11a on one side, in which the circling portion 402 is placed between the first magnetic portion 11a and the second magnetic portion 11b, and includes the second magnetic portion 11b on the other side facing the one side.

In the example illustrated in FIG. 4, the first magnetic portion 11a is positioned closer to the bottom surface 102 of the circling portion 402, and the second magnetic portion 11b is positioned closer to the upper surface 101 of the circling portion 402. The first magnetic portion 11a and the second magnetic portion 11b surround the circling portion 402 to form a closed magnetic circuit in the magnetic base 11.

The external electrodes 12 are provided on the surface of the first magnetic portion 11a. That is, the external electrodes 12 are provided on the external surface of the magnetic base 11 and provided in contact with the first magnetic portion 11a. The magnetic base 11 is insulating as described above, and therefore, the external electrodes 12 can be directly provided on the external surface of the magnetic base 11. In the example illustrated in FIG. 4, the first magnetic portion 11a is positioned closer to the bottom surface 102 of the circling portion 402, and therefore, the external electrodes 12 are provided closer to the bottom surface 102 of the magnetic base 11.

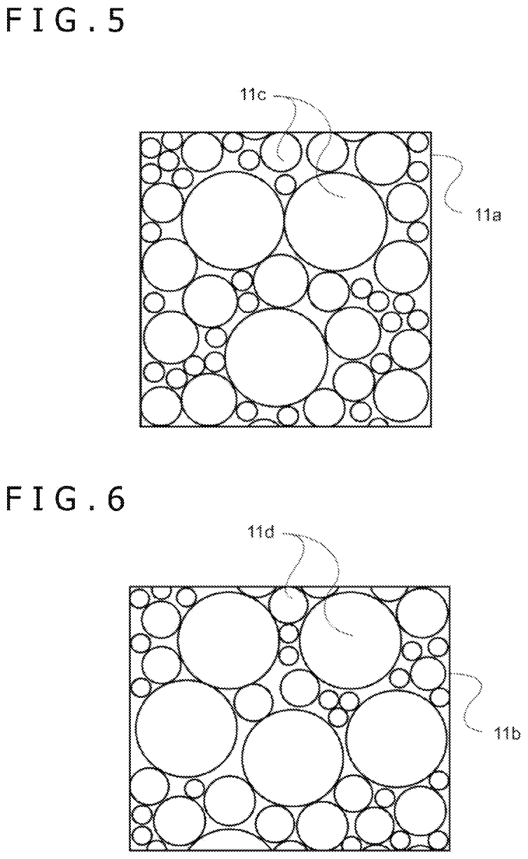

FIG. 5 is a schematic enlarged view illustrating a microscopic structure of the first magnetic portion 11a, and FIG. 6 is a schematic enlarged view illustrating a microscopic structure of the second magnetic portion 11b.

First metal particles 11c are bound with each other in the structure of the first magnetic portion 11a. The first metal particles 11c have a particle size distribution, and the average particle size thereof is 3 to 30 μm.

Second metal particles 11d are bound with each other in the structure of the second magnetic portion 11b. The second metal particles 11d have a particle size distribution, and the average particle size thereof is 2 to 15 μm.

The average particle size of the first metal particles 11c is in a range of equal to or greater than 1.5 times to equal to or smaller than five times the average particle size of the second metal particles 11d. Metal particles with appropriate particle sizes based on values obtained by, for example, a laser-diffraction particle size distribution measurement apparatus are selected as the first metal particles 11c and the second metal particles 11d satisfying such a relation of particle size, and the metal particles are used to produce the magnetic base 11.

When the particle sizes of the first metal particles 11c and the second metal particles 11d are to be obtained after the production of the magnetic base 11, the cross section of the magnetic base 11 is observed by, for example, an optical microscope, and the particle sizes are obtained from maximum dimensions of particle external shapes of individual particles. Particles with maximum dimension of equal to or greater than 1 μm are selected for the average particle size, and an average value in a certain area of the cross section of the magnetic base 11 is calculated.

The first metal particles 11c and the second metal particles 11d may be particles containing the same type of magnetic material or may be particles containing different types of magnetic materials. Each of the first metal particles 11c and the second metal particles 11d may be particles containing a single type of magnetic material or may be particles with a combination of a plurality of types of magnetic materials.

The filling rates of the magnetic metal materials of the magnetic base 11 are equal to or greater than 79 vol % and equal to or smaller than 87 vol %. The filling rates of the magnetic metal materials in the first magnetic portion 11a and the second magnetic portion 11b are the same, or the filling rate is 5% higher in the second magnetic portion 11b. Therefore, the relative permeability is in a range of equal to or greater than 30 and equal to or smaller than 50 in both the first magnetic portion 11a and the second magnetic portion 11b. The first magnetic portion 11a has a relative permeability higher than that of the second magnetic portion 11b, and the relative permeability of the first magnetic portion 11a is higher than that of the second magnetic portion 11b by a range of equal to or greater than 5% to equal to or smaller than 20%. When the relative permeabilities are in this range, the magnetic base 11 can guide most of a magnetic flux 410 (see FIG. 4) inside, and a closed magnetic circuit is realized in the coil component 1 as a whole.

The first magnetic portion 11a and the second magnetic portion 11b have the filling rates described above, and the average particle size of the first metal particles 11c is larger than the average particle size of the second metal particles 11d. Therefore, the magnetic saturation characteristics of the second magnetic portion 11b are higher than those of the first magnetic portion 11a.

The description will be continued with reference again to FIG. 4.

The magnetic base 11 includes the first magnetic portion 11a and the second magnetic portion 11b, and therefore, the magnetic base 11 has desirable magnetic characteristics. In particular, the first magnetic portion 11a contributes to the permeability, and the second magnetic portion 11b contributes to the suppression of loss. Therefore, the coil component 1 can suppress the loss while securing the permeability, and the coil component 1 can more efficiently obtain the magnetic performance.

A minimum thickness D1 of the first magnetic portion 11a in contact with the external electrode 12 is, for example, equal to or greater than 0.2 mm and equal to or smaller than 0.5 mm, and a minimum thickness D2 of the second magnetic portion 11b is, for example, equal to or greater than 0.05 mm and equal to or smaller than 0.2 mm. A ratio D2/D1 of the thickness D2 to the thickness D1 is, for example, smaller than 1 and equal to or greater than 0.2. That is, the minimum thickness of the first magnetic portion 11a in contact with the external electrode 12 is larger than the minimum thickness of the second magnetic portion 11b.

The thickness of each of the first magnetic portion 11a and the second magnetic portion 11b is the distance from the conductor 14 to the external surface of the magnetic base 11. The minimum thickness of the first magnetic portion 11a in contact with the external electrode 12 is the shortest distance from the external electrode 12 to the conductor 14 and is the minimum distance of the first magnetic portion 11a placed between the external electrode 12 and the conductor 14. The minimum thickness of the second magnetic portion 11b is the shortest distance from the conductor 14 at the part without the external electrode 12 to the external surface of the second magnetic portion 11b and is the minimum distance of the second magnetic portion 11b.

The minimum thickness of each of the first magnetic portion 11a and the second magnetic portion 11b is obtained by observation of the cross section at the target part. That is, the minimum thickness is obtained at a given cross section orthogonal to the surface where the external electrode 12 extends and also orthogonal to the current flowing through the circling portion 402.

FIG. 4 illustrates the magnetic flux 410 generated in the circling portion 402 of the conductor 14. The closed magnetic circuit is realized in the coil component 1 as a whole, and therefore, only part of the magnetic flux 410 reaches the outside of the magnetic base 11. However, the loss caused by the magnetic flux 410 leaked outside of the magnetic base 11 needs to be suppressed.

The minimum thickness of the first magnetic portion 11a is larger than the minimum thickness of the second magnetic portion 11b, and a sufficient thickness can be obtained on the first magnetic portion 11a side. As a result, the magnetic flux 410 passing through the first magnetic portion 11a does not exceed the acceptable range that allows confinement of the magnetic flux 410 in the first magnetic portion 11a even at the section with minimum thickness, and the leakage of the magnetic flux 410 is suppressed. As a result, while part of the magnetic flux 410 is leaked outside the magnetic base 11 on the second magnetic portion 11b side, the magnetic flux 410 is substantially confined inside the magnetic base 11 on the first magnetic portion 11a side. As described above, the external electrodes 12 are provided on the surface of the first magnetic portion 11a, and this suppresses the loss that occurs when the magnetic flux 410 passes through the external electrodes 12.

The magnetic flux 410 leaked outside the magnetic base 11 affects not only the inside the coil component 1, but also the circuit board 2 on which the coil component 1 is mounted. The loss that particularly occurs at the land portions 3 in the pattern formed on the board 2a needs to be suppressed. As illustrated in FIGS. 1 and 2, the external electrodes 12 are soldered to the land portions 3 when the coil component 1 is mounted. Therefore, the loss at the land portions 3 caused by the magnetic flux 410 is also suppressed by providing the external electrodes 12 on the surface of the first magnetic portion 11a.

Although FIG. 4 illustrates an example in which the external electrodes 12 are provided on only one surface that is the bottom surface 102, the external electrodes 12 may be provided on, for example, two surfaces including the bottom surface 102 and the end surface 103. Here, it is preferable that the area and the thickness of the external electrodes 12 be small. It is desirable that the area of the part of the external electrodes 12 provided on the end surface 103 be smaller than the area of part of the external electrodes 12 provided on the bottom surface 102. It is also desirable that the thickness of the part of the external electrodes 12 provided on the end surface 103 be smaller than the thickness of the part of the external electrodes 12 provided on the bottom surface 102.

### Other Embodiments

Other embodiments of the coil component of the present disclosure will be described. Differences from the first embodiment will be mainly described. Constituent elements similar to the constituent elements of the first embodiment are provided with the same reference signs, and the description will not be repeated.

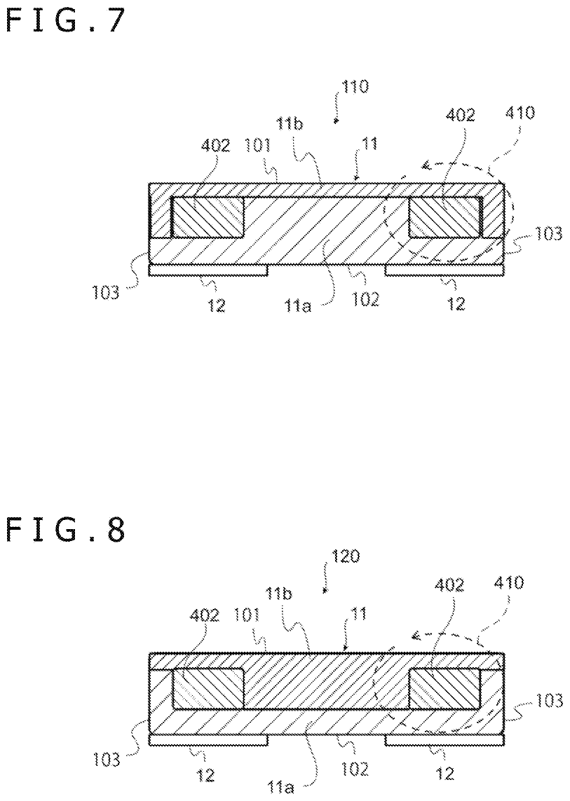

FIG. 7 depicts a coil component 110 of a second embodiment.

In the coil component 110 of the second embodiment, the first magnetic portion 11a extends between the external electrodes 12 and the second magnetic portion 11b and reaches the end surfaces 103. As a result, the external electrodes 12 are provided separately from the second magnetic portion 11b.

The external electrodes 12 are separated from the second magnetic portion 11b, and therefore, the influence of the leakage of the magnetic flux 410 from the second magnetic portion 11b at the external electrodes 12 is reduced compared to when the second magnetic portion 11b and the external electrodes 12 are in contact with each other. This further suppresses the loss at the external electrodes 12.

FIG. 8 depicts a coil component 120 of a third embodiment.

In the coil component 120 of the third embodiment, the second magnetic portion 11b is provided on an inner circumferential side of the circling portion 402, and the first magnetic portion 11a is provided on an outer circumferential side of the circling portion 402. This suppresses the leakage of the magnetic flux 410 on the end surface 103 side. Therefore, the influence of the magnetic flux 410 on, for example, other electronic components is small, and they can be mounted at high density.

### Example

An example of the coil component 1 of the first embodiment with specific numerical examples will be described.

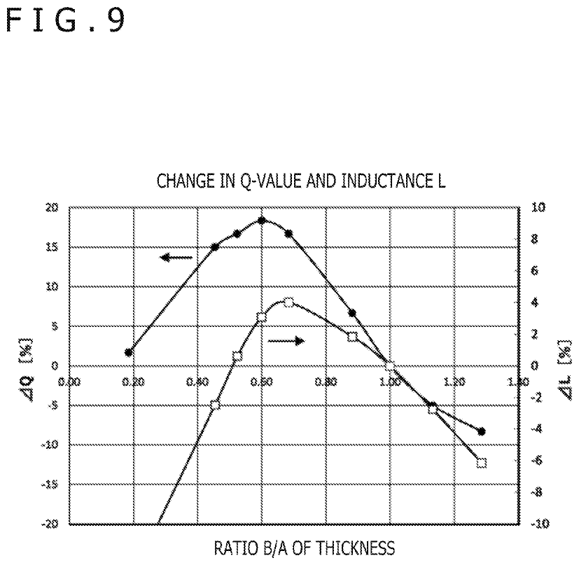

FIG. 9 is a graph illustrating a Q-value and inductance in the example.

The horizontal axis of FIG. 9 represents the ratio D2/D1 of the minimum thickness of the second magnetic portion 11b to the minimum thickness of the first magnetic portion 11a. The vertical axis on the right side of FIG. 9 represents a change (ΔL) in inductance based on the ratio D2/D1 of 1. The vertical axis on the left represents a change (ΔQ) in Q-value based on the ratio D2/D1 of 1.

In calculating the Q-value and the inductance, the relative permeability of the first magnetic portion 11a is 35, and the relative permeability of the second magnetic portion 11b is 30. As for the size of the coil component 1, the length is 2.0 mm, the width is 1.6 mm, and the height is 0.8 mm. The height of the coil component 1 and the size of the conductor 14 are fixed, and therefore, the minimum thicknesses D1 and D2 of the first magnetic portion 11a and the second magnetic portion 11b change in conjunction. The minimum thickness D1 of the first magnetic portion 11a and the minimum thickness D2 of the second magnetic portion 11b are changed on the basis of 0.16 mm.

Results of calculating the Q-value and the inductance with respect to the ratio D2/D1 of minimum thickness are illustrated in the graph. The Q-value is illustrated in the graph with black circles, and the inductance is illustrated in the graph with white rectangles. It can be recognized that the Q-value and the inductance decrease when the ratio D2/D1 is larger than “1,” compared to the Q-value and the inductance when the ratio D2/D1 is “1.”

The Q-value has a relation of Q=2πfL/R with respect to frequency f, inductance L, and resistance R, and the reciprocal of the Q-value is the loss factor. Therefore, when the minimum thickness D1 of the first magnetic portion 11a is smaller than the minimum thickness D2 of the second magnetic portion 11b, the loss is larger than when they are equal. This may be because, if the minimum thickness D1 of the first magnetic portion 11a is small, the magnetic flux 410 passes through the external electrodes 12 and the loss occurs due to the eddy current loss.

On the other hand, it can be recognized that, when the ratio D2/D1 is smaller than “1,” the Q-value and the inductance tend to increase compared to when the ratio D2/D1 is “1.” Therefore, when the minimum thickness D1 of the first magnetic portion 11a is larger than the minimum thickness D2 of the second magnetic portion 11b, the loss is smaller than when they are equal. This may be because the minimum thickness D1 of the first magnetic portion 11a with high permeability is thicker, so that the leakage of the magnetic flux 410 on the first magnetic portion 11a side is reduced, and the magnetic flux 410 passing through the external electrodes 12 is also reduced.

What is claimed is:

1. A coil component comprising:
a conductor including a circling portion and an extension portion;
a magnetic base containing magnetic metal particles and including the circling portion; and
an external electrode electrically connected to the extension portion, wherein
the magnetic base includes a first magnetic portion containing first magnetic metal particles and a second magnetic portion containing second magnetic metal particles with a particle size smaller than that of the first magnetic metal particles, the first magnetic portion is positioned on one side and the second magnetic portion is positioned on another side across the circling portion, and
the external electrode is provided in contact with the first magnetic portion.

2. The coil component according to claim 1, wherein
the external electrode is provided separately from the second magnetic portion.

3. The coil component according to claim 1, wherein
a minimum thickness of the first magnetic portion is larger than a minimum thickness of the second magnetic portion.

4. The coil component according to claim 1, wherein
the first magnetic portion is provided on a side closer to a bottom surface of the magnetic base, the bottom surface side facing a board when the coil component is mounted, and the second magnetic portion is provided on a side closer to an upper surface of the magnetic base, the upper surface side being opposite the bottom surface side, and
the coil component is mounted on the board by the external electrode provided on the bottom surface.
